(19) United States
(12) Patent Application Publication
(10) Pub. No.: US 2009/0318607 A1
(43) Pub. Date: Dec. 24, 2009

(54) LAYER MATERIALS WITH IMPROVED ADHESION COMPRISING ELASTIC POLYURETHANE BINDER AND PLASTICS GRANULES

(75) Inventors: Markus Schütte, Osnabruck (DE); Berend Eling, Lemforde (DE); Bernd Bruchmann, Freinsheim (DE); Daniel Schönfelder, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/515,156

(22) PCT Filed: Nov. 12, 2007
(86) PCT No.: PCT/EP07/62187

§ 371 Date: May 15, 2009

(30) Foreign Application Priority Data
Nov. 15, 2006 (EP) 06124097.4

(51) Int. Cl. C08L 75/04; C08G 18/10

(52) U.S. Cl. 524/507; 528/60

(57) ABSTRACT

The present invention relates to a polyurethane binder for production of elastic layer materials comprising plastics granules, where the polyurethane binder comprises hyperbranched polymer, and to a process for production of these polyurethane binders. The present invention further relates to elastic layer materials obtainable via mixing of this polyurethane binder and plastics granules, and also, if appropriate, other auxiliaries and additives, and hardening of the mixture, to a process for production of these layer materials, and to the use of the inventive layer materials as floorcoverings for sports surfaces, e.g. playing areas, athletics tracks, and sports halls, and for children's play areas, and for walkways.

The present invention relates to a polyurethane binder for production of elastic layer materials comprising plastics granules, where the polyurethane binder comprises hyperbranched polymer, and to a process for production of these polyurethane binders. The present invention further relates to elastic layer materials obtainable via mixing of this polyurethane binder and plastics granules, and also, if appropriate, other auxiliaries and additives, and hardening of the mixture, to a process for production of these layer materials, and to the use of the inventive layer materials as floorcoverings for sports surfaces, e.g. playing areas, athletics tracks, and sports halls, and for children's play areas, and for walkways.

Further embodiments of the present invention are found in the claims, in the description, and in the examples. The abovementioned features of the inventive subject matter, and those that will be explained at a later stage below can, of course, be used not only in the respective cited combination, but also in other combinations, without going beyond the scope of the invention.

The production of elastic layer materials comprising rubber particles or comprising plastics particles and using suitable binders is known.

By way of example, DE 1 534 345 describes water-permeable, elastic floorcoverings for sports surfaces, without any further explanation of the chemical constitution of the binder used. DE 1 955 267, and DE 1 720 059, and also DE 2 156 225 and DE 2 215 893 describe the use of two-component polyurethane binders for bonding of elastic particles. DE 2021 682, DE 2 228 111, DE 2 427 897, DE 2 447 625, and DE 2 821 001 by way of example describe moisture-curing single-component polyurethane binders for this application sector. The plastics particles used mostly comprise rubber granule particles, mainly for reasons of cost.

The mechanical strength of these layer materials is mostly subject to a limit deriving from the adhesion of polyurethane binder and rubber, this being only low. The result can be partial destruction or premature wear of the composite material on exposure to severe stress, for example caused by frequent use or use of spikes.

To improve adhesion between rubber granule particles and binder, DE 2 455 679 proposes, in a first operation, coating the rubber granules with a paste composed of polyethers comprising hydroxy groups, of mineral fillers, and/or of pigments, and then mixing with the polyisocyanate binder and hardening.

A disadvantage of this process is that it is a two-stage process with increased operator cost, and provides only a slight increase in tensile strain at break and tensile strength.

It was therefore an object of the invention to provide a polyurethane binder for production of elastic layer materials comprising plastics granules which has no additional steps of processing in production of the layer material, and can give improved adhesion of the binder and of the plastics granules, apparent by way of example in increased tensile strength.

Another object of the invention was to provide a process for production of these binders.

Another object of the present invention was to provide elastic layer materials which have longer lifetime and higher load-bearing capacity than layer materials of the prior art.

The inventive object is achieved via a polyurethane binder for production of elastic layer materials which comprise plastics granules, where the polyurethane binder comprises a hyperbranched polymer. The inventive object is further achieved via an elastic layer material obtainable via mixing of an inventive polyurethane binder with the plastics granules and hardening of the mixture.

For the purposes of this invention, plastics are thermoset plastics, elastomeric plastics, and thermoplastics.

Thermoset plastics are plastics which have irreversible and dense crosslinking by way of covalent bonds. Thermoset plastics are energy-elastic at low temperatures, and even at relatively high temperatures they are incapable of viscous flow and instead behave elastically with very restricted deformability. Shear modulus is never less than 10² kp/cm² at any temperature. Among the thermoset plastics are, inter alia, the following industrially important groups of substances: diallyl phthalate resins, epoxy resins, urea-formaldehyde resins, melamine-formaldehyde resins, melamine-phenol-formaldehyde resins, phenol-formaldehyde resins, and unsaturated polyester resins.

Elastomeric plastics are polymers with elastomeric behavior which at 20° C. can be repeatedly elongated at least to 1.5 times their length and which immediately regain approximately their initial dimensions once the force required for the elongation has been removed.

Thermoplastics are polymeric materials which are hard or soft at service temperature and which above service temperature have a flow transition region. Thermoplastics are composed of linear or branched polymers which in principle become flowable above the glass transition temperature (T_{g}) in the case of amorphous thermoplastics or above the melting point (Tₘ) in the case of (semi)crystalline thermoplastics.

It is preferable that the plastics granules used comprise elastomeric plastics. It is particularly preferable that the elastomeric plastics used comprise vulcanized rubber mixtures, for example composed of butadiene rubber (BR), styrene-butadiene rubber (SBR), isoprene rubber (IR), styrene-isoprene-butadiene rubber (SIBR), acrylonitrile-butadiene rubber (NBR), chloroprene rubber (CR), isobutene-isoprene rubber (IIR), EPDM and natural rubber (NR), either pure or in the form of blends with one another, these having been mixed with vulcanization accelerators and/or with crosslinking agents based on sulfur or on peroxide, and vulcanized according to familiar practice. EPDM here is a rubber whose preparation uses terpolymerization of ethene and of relatively large proportions of propylene, and also of a few percent of a third monomer having diene structure, the diene monomer in the rubber providing the double bonds needed for subsequent sulfur-vulcanization. Diene monomers mainly used are cis,cis-1,5-cyclooctadiene (COD), exo-dicyclopentadiene (DCP), endo-dicyclopentadiene (EDCP), and 1,4-hexadiene (HX), and among many others 5-ethylidene-2-norbornene (ENB). The elastomers used particularly preferably comprise vulcanized styrene-butadiene rubber, or comprise styrene-butadiene rubber blends with, for example, EPDM, or comprise EPDM.

The elastomers here comprise, if appropriate, commercially available fillers, such as carbon blacks, silica, chalk, metal oxides, plasticizers, antioxidants, antiozonants, and/or thermoplastic polymers, such as thermoplastics comprising styrene, e.g. polystyrene or polystyrene-acrylonitrile (SAN), or ethylene-vinyl acetate (EVA), polyethylene, polypropylene, polycarbonate, thermoplastic polyurethane (TPU), polyvinyl chloride (PVC), or thermoplastic elastomers based on styrene-butadiene-styrene block copolymers or on styrene-isoprene-styrene block copolymers, or blends composed of the specified thermoplastics with one another.

The plastics granules used in the inventive process can be of any desired size and shape. However, it is preferable to use elastic granules composed of rubber wastes or of plastics wastes, their grain sizes being from 0.5 to 60 mm, preferably from 1 to 10 mm. By way of example, these wastes arise during tire retreading and during manufacture of industrial items composed of rubber or of plastic. For financial reasons, it is preferable to use wastes from tire retreading.

A polyurethane binder here is a mixture composed of at least 50% by weight, preferably at least 80% by weight, and in particular at least 95% by weight, of a prepolymer which has isocyanate groups, hereinafter termed isocyanate prepolymer, and of hyperbranched polymer. The isocyanate prepolymer and the hyperbranched polymer here can be present in the form of a purely physical mixture, or the hyperbranched polymer can have been bonded via covalent bonding to the isocyanate prepolymer. Covalent bonding of the hyperbranched polymer to the polymer matrix of the isocyanate prepolymer is preferred here.

The viscosity of the inventive polyurethane binder here is preferably in the range from 500 to 4000 mPa·s, particularly preferably from 1000 to 3000 mPa·s, measured at 25° C. to DIN 53 018.

The prepolymers which have isocyanate groups here can be prepared via reaction of polyisocyanates (a) with compounds (b) reactive toward isocyanates, with hyperbranched polymer (c), and also, if appropriate, with chain extenders and/or crosslinking agents (d), where an excess of the polyisocyanate (a) is used.

Polyisocyanates (a) that can be used here are any of the aliphatic, cycloaliphatic, and aromatic di- or polyfunctional isocyanates known from the prior art, or else any desired mixture thereof. Examples are diphenylmethane 4,4′-, 2,4′-, and 2,2′-diisocyanate, mixtures composed of monomeric diphenylmethane diisocyanates and of diphenylmethane diisocyanate homologs having a greater number of rings (polymer MDI), tetramethylene diisocyanate, hexamethylene diisocyanate (HDI), isophorone diisocyanate (IPDI), naphthalene 1,5-diisocyanate (NDI), toluene 2,4,6-triisocyanate, and toluene 2,4- and 2,6-diisocyanate (TDI), or a mixture thereof.

It is preferable to use toluene 2,4-diisocyanate, toluene 2,6-diisocyanate, diphenylmethane 2,4′-diisocyanate, and diphenylmethane 4,4′-diisocyanate, and diphenylmethane diisocyanate homologs having a greater number of rings (polymer MDI), and also mixtures of these isocyanates, uretonimine in particular a mixture composed of diphenylmethane 2,4′-diisocyanate and diphenylmethane 4,4′-diisocyanate, as polyisocyanate (a).

Compounds (b) used which are reactive toward isocyanates can be any of the compounds having at least two hydrogen atoms reactive toward isocyanate groups. It is preferable to use polyesterols, polyetherols, or a mixture of polyetherols with polyols which have a tertiary amine group, in particular to use polyetherols.

Polyols which have tertiary amino groups can by way of example be obtained via reaction of secondary amines, such as ethylenediamine, with alkylene oxides, such as ethylene oxide or propylene oxide.

Suitable polyetherols are prepared by known processes, for example via anionic polymerization from one or more alkylene oxides having from 2 to 4 carbon atoms in the alkylene radical, using alkali metal hydroxides or alkali metal alcoholates as catalysts, and with addition of at least one starter molecule which comprises from 2 to 5, preferably from 2 to 4, and particularly preferably from 2 to 3, in particular 2, reactive hydrogen atoms in the molecule, or via cationic polymerization using Lewis acids, such as antimony pentachloride or boron trifluoride etherate. Other catalysts that can be used are multimetal cyanide compounds, known as DMC catalysts. Examples of suitable alkylene oxides are tetrahydrofuran, propylene 1,3-oxide, butylene 1,2-oxide, butylene 2,3-oxide, and preferably ethylene oxide and propylene 1,2-oxide. The alkylene oxides can be used individually, in alternation in succession, or in the form of a mixture. It is preferable to use propylene 1,2-oxide, ethylene oxide, or a mixture composed of propylene 1,2-oxide and ethylene oxide.

Starter molecules that can be used are preferably water or di- and trihydric alcohols, e.g. ethylene glycol, 1,2- or 1,3-propanediol, diethylene glycol, dipropylene glycol, 1,4-butanediol, glycerol, and trimethylolpropane.

The functionality of the preferred polyether polyols, particularly preferably polyoxypropylene polyols or polyoxypropylene polyoxyethylene polyols, is from 2 to 5, particularly preferably from 2 to 3, and their molar mass is from 400 to 9000 g/mol, preferably from 1000 to 6000 g/mol, particularly preferably from 1500 to 5000 g/mol, and in particular from 2000 to 4000 g/mol. The polyether polyol used particularly preferably comprises polypropylene glycol whose weight-average molar mass is from 1500 to 2500 g/mol.

For the purposes of the invention, hyperbranched polymers (c) are any of the polymers whose weight-average molar mass is greater than 500 g/mol and whose main chain has branching, and whose degree of branching (DB) is greater than or equal to 0.05. These are preferably hyperbranched polymers (c) whose weight-average molar mass is greater than 800 g/mol, particularly preferably greater than 1000 g/mol, and in particular greater than 1500 g/mol, and whose degree of branching is 0.1 or greater. The degree of branching of the inventive hyperbranched polymers (c) is particularly preferably from 0.2 to 0.99 and in particular from 0.3 to 0.95, and very specifically from 0.35 to 0.75. For the definition of “degree of branching”, reference is made to H. Frey et al., Acta Polym. 1997, 48, 30.

Preferred hyperbranched polymers (c) are those based on ethers, on amines, on esters, on carbonates, on amides, on urethanes, and on ureas, or else on mixed forms of these, for example on ester amides, on amido amines, on ester carbonates, and on urea urethanes. Hyperbranched polymers (c) that can in particular be used are hyperbranched polyethers, polyesters, polyesteramides, polycarbonates, or polyester carbonates. These polymers and processes for their preparation are described in EP 1141083, in DE 102 11 664, in WO 00/56802, in WO 03/062306, in WO 96/19537, in WO 03/54204, in WO 03/93343, in WO 05/037893, in WO 04/020503, in DE 10 2004 026 904, in WO 99/16810, in WO 05/026234, and in DE 10 2005 009 166.

In one embodiment, the inventive hyperbranched polymers (c) have various functional groups. These functional groups are preferably capable of reacting with isocyanates and/or with reactive groups of the plastics granules, for example of rubber granules, or else of interacting with the polymer, for example rubber.

Examples of the functional groups which are reactive toward isocyanates are hydroxy groups, amino groups, mercapto groups, epoxy groups, carboxy groups, or anhydride groups, preferably hydroxy groups, amino groups, mercapto groups, or anhydride groups.

Examples of the functional groups which can react with the reactive groups of the polymer, for example rubber, are groups capable of free-radical polymerization, e.g. olefinic double bonds, triple bonds, or activated double bonds, e.g. vinyl groups, (meth)acrylate groups, maleic acid groups or fumaric acid groups, or groups comprising derivatives thereof.

The functional groups which can interact with the polymer, for example rubber, are units which do not react covalently with the solid but have interactions by way of positively or negatively charged groups, by way of electronic donor or acceptor bonding, by way of coordinative interactions, by way of hydrogen bonds, by way of Van der Waals bonds, or by way of hydrophobic interactions.

Units generating hydrogen bonding or donor and acceptor bonding can, for example, be hydroxy groups, amino groups, mercapto groups, epoxy groups, carboxy groups, or anhydride groups, carbonyl groups, ether groups, olefinic double bonds, conjugated double bonds, triple bonds, activated double bonds, e.g. (meth)acrylate groups, or groups comprising maleic acid or comprising fumaric acid or comprising derivatives thereof.

Molecular domains generating Van der Waals bonds or hydrophobic interactions can, for example, be linear or branched alkyl, alkenyl, or alkynyl radicals whose chain length is from C₁ to C₁₂₀, or aromatic systems having from 1 to 10 ring systems, which may also have substitution by heteroatoms, such as nitrogen, phosphorus, oxygen, or sulfur. It is also possible to use linear or branched polyether molecular domains based on ethylene oxide, propylene oxide, butylene oxide, styrene oxide, or a mixture thereof, or else polyethers based on tetrahydrofuran or butanediol.

In one preferred embodiment, the hyperbranched polymers (c) have not only groups reactive toward isocyanate but also groups which react with the solid or interact with the solid, for example the following structures obtained by way of the linking of the monomers: ester structures, ether structures, amide structures, and/or carbonate structures, and also hydroxy groups, carboxy groups, amino groups, anhydride groups, vinyl groups, (meth)acrylic double bonds, maleic double bonds, and/or long-chain linear or branched alkyl radicals.

The inventive hyperbranched polymers (c) generally have an acid number of from 0 to 50 mg KOH/g, preferably from 1 to 35 mg KOH/g, and particularly preferably from 2 to 20 mg KOH/g, and in particular from 2 to 10 mg KOH/g, to DIN 53240, part 2.

The hyperbranched polymers (c) moreover generally have a hydroxy number of from 0 to 500 mg KOH/g, preferably from 10 to 500 mg KOH/g, and particularly preferably from 10 to 400 mg KOH/g, to DIN 53240, part 2.

The inventive hyperbranched polymers (c) generally moreover have a glass transition temperature (measured to ASTM method D3418-03 using DSC) of from −60 to 100° C., preferably from −40 to 80° C.

The inventive high-functionality, hyperbranched polymers (c) are preferably amphiphilic polymers. The amphiphilic properties are preferably obtained via introduction of hydrophobic radicals into a hydrophilic, hyperbranched polymer, for example a hyperbranched polymer based on a polyester. These hydrophobic radicals preferably have more than 6, particularly preferably more than 8, and less than 100, and in particular more than 10, and less than 50, carbon atoms.

The hydrophobicization can be achieved during the esterification reaction by way of example via partial or complete replacement of di- and/or polycarboxylic acids or di- and/or polyols by mono-, di-, and/or polycarboxylic acids comprising an appropriate hydrophobic radical, or mono-, di-, and/or polyols comprising an appropriate hydrophobic radical. Examples of these mono-, di-, or polycarboxylic acids comprising a hydrophobic radical are aliphatic carboxylic acids, such as octanoic acid, decanoic acid, dodecanoic acid, tetradecanoic acid, fatty acids, such as stearic acid, oleic acid, lauric acid, palmitic acid, linoleic acid, linolenic acid, aromatic carboxylic acids, such as phthalic acid, isophthalic acid, terephthalic acid, trimellitic acid, cycloaliphatic carboxylic acids, such as cyclohexanedicarboxylic acid, dicarboxylic acids, such as octanedioic acid, decanedioic acid, dodecanedioic acid, tetradecanedioic acid, and dimeric fatty acids. Examples of mono-, di-, or polyols comprising a hydrophobic radical are aliphatic alcohols, such as the isomers of octanol, of decanol, of dodecanol, of tetradecanol, fatty alcohols, such as stearyl alcohol, oleyl alcohol, unsaturated alcohols, such as allyl alcohol, crotyl alcohol, aromatic alcohols, such as benzyl alcohol, cycloaliphatic alcohols, such as cyclohexanol and also fatty acid monoglycerides, e.g. glycerol monostearate, glycerol monooleate, glycerol monopalmitate.

The hyperbranched polymers (c) generally have HLB value of from 1 to 20, preferably from 3 to 20, and particularly preferably from 4 to 20. If alkoxylated alcohols are used in the structure of the inventive high-functionality, highly branched and hyperbranched polymers (c), the HLB value is preferably from 5 to 8.

The HLB value is a measure of the hydrophilic and lipophilic content of a chemical compound. Determination of the HLB value is explained by way of example in W. C Griffin, Journal of the Society of Cosmetic Chemists, 1949, 1, 311 and W. C Griffin, Journal of the Society of Cosmetic Chemists, 1954, 5, 249.

For polyesters and hydrophobicized polyesters, the HLB value gives the ratio of the number of ethylene oxide groups multiplied by 100 to the number of carbon atoms in the lipophilic moiety of the molecule, and is calculated as follows by the method of C. D. Moore, M. Bell, SPC Soap, Perfum. Cosmet. 1956, 29, 893:

HLB=(number of ethylene oxide groups)*100/(number of carbon atoms in lipophilic moiety of molecule)

In one particularly preferred embodiment, the hyperbranched polymer (c) used comprises a hyperbranched polyester d1) obtained via esterification of α,β-unsaturated carboxylic acids or of their derivatives with a polyhydric alcohol to give the polyester. Examples of α,β-unsaturated carboxylic acids or their derivatives used are preferably dicarboxylic acids or their derivatives, and in one particularly preferred embodiment here the double bond is adjacent to each of the two carboxy groups. Examples of these particularly preferred α,β-unsaturated carboxylic acids or their derivatives are maleic anhydride, maleoyl chloride, fumaroyl chloride, fumaric acid, itaconic acid, itaconoyl chloride, and/or maleic acid, preferably maleic acid, maleic anhydride, or maleoyl chloride, particularly preferably maleic anhydride. The α,β-unsaturated carboxylic acids or their derivatives here can be used alone, in the form of a mixture with one another, or together with further carboxylic acids, preferably with di- or polycarboxylic acids, or with their derivatives, particularly preferably with dicarboxylic acids or with their derivatives, e.g. adipic acid. The expression “α,β-unsaturated carboxylic acids or their derivatives” below includes mixtures comprising two or more α,β-unsaturated carboxylic acids and mixtures comprising one or more α,β-unsaturated carboxylic acids and further carboxylic acids.

Polyesters (c1) based on maleic anhydride are described by way of example in DE 10 2004 026 904, WO 2005/037893. The polyhydric alcohol used preferably comprises a polyetherol or polyesterol, for example as described under (b), or a mixture of various polyols. The average functionality of the entire mixture of the alcohols used here is from 2.1 to 10, preferably from 2.2 to 8, and particularly preferably from 2.2 to 4.

In the reaction of the α,β-unsaturated carboxylic acids or their derivatives with the polyhydric alcohol, the ratio of the reactive partners in the reaction is preferably selected in such a way as to comply with a molar ratio of molecules having groups reactive toward acid groups or toward their derivatives to molecules having acid groups or their derivatives of from 2:1 to 1:2, particularly preferably from 1.5:1 to 1:2, very particularly preferably from 0.9:1 to 1:1.5, and in particular 1:1. The reaction here is carried out under reaction conditions under which acid groups or their derivatives and groups reactive toward acid groups or toward their derivatives react with one another. The particularly preferred hyperbranched polyesters are prepared via reaction of the α,β-unsaturated carboxylic acids or their derivatives with the polyhydric alcohol preferably at temperatures of from 80 to 200° C., particularly preferably of from 100 to 180° C. The preparation of the particularly preferred hyperbranched polyesters here can take place in bulk or in solution. Examples of suitable solvents are hydrocarbons, such as paraffins or aromatics. Particularly suitable paraffins are n-heptane, cyclohexane, and methylcyclohexane. Particularly suitable aromatics are toluene, ortho-xylene, meta-xylene, para-xylene, xylene in the form of isomer mixture, ethylbenzene, chlorobenzene, and ortho- and meta-dichlorobenzene. Other suitable solvents are ethers, such as dioxane or tetrahydrofuran, and ketones, such as methyl ethyl ketone and methyl isobutyl ketone.

The pressure conditions during the preparation of the particularly preferred polyesters (c1) via reaction of α,β-unsaturated carboxylic acids or their derivatives with the polyhydric alcohol are per se non-critical. It is possible to operate at markedly subatmospheric pressure, for example at from 1 to 500 mbar. Their preparation process can also be carried out at pressures above 500 mbar. It is also possible to carry out the reaction at atmospheric pressure, and a reaction at slightly superatmospheric pressure, for example up to 1200 mbar, is also possible. It is also possible to operate at markedly superatmospheric pressure, for example at pressures of up to 10 bar. For reasons of simplicity, preference is given to the reaction at atmospheric pressure. The reaction at subatmospheric pressures is likewise preferred. The reaction time is usually from 10 minutes to 48 hours, preferably from 30 minutes to 24 hours, and particularly preferably from 1 to 12 hours.

The resultant particularly preferred hyperbranched polyesters (c1) have a weight-average molar mass of from 1000 to 500 000, preferably from 2000 to 200 000, particularly preferably from 3000 to 120 000, g/mol, determined by means of PMMA-calibrated GPC.

In another particularly preferred embodiment, the hyperbranched polymer used comprises a hydrophobicized hyperbranched polyester (c2). The procedure here for preparation of the hydrophobicized hyperbranched polyester (c2) is analogous to that for preparation of the hyperbranched polyester (c1), but all of, or some of, the α,β-unsaturated carboxylic acids or their derivatives used have been hydrophobicized. The α,β-unsaturated carboxylic acids used here are preferably maleic acid, maleic anhydride, and fumaric acid, particularly preferably maleic anhydride. This hydrophobicization can take place after, or preferably prior to, the reaction with the alcohol to give the polyester. Hydrophobicizing agents that can be used preferably comprise hydrophobic compounds comprising at least one carbon-carbon double bond, e.g. linear or branched polyisobutylene, polybutadiene, polyisoprene, and unsaturated fatty acids or their derivatives. The reaction with the hydrophobicizing agents here takes place by processes known to the person skilled in the art, using an addition reaction of the hydrophobicizing agent onto the double bond in the vicinity of the carboxy group, as described by way of example in the German Laid-Open specifications DE 195 19 042 and DE 43 19 671. Particularly preferred hydrophobicized hyperbranched polyesters (c2) of this type and their preparation are described by way of example in the prior application with file reference DE 10 2005 060 783.7. It is preferable here to start from polyisobutylene whose molar mass is from 100 to 10 000 g/mol, particularly preferably from 500 to 5000 g/mol, and in particular from 550 to 2000 g/mol. Particularly preferred hydrophobicized, hyperbranched polyesters (c2) are hyperbranched polyesters (c2) which comprise an adduct composed of reactive polyisobutylene and maleic anhydride, the term used being polyisobutylenesuccinic acid (PIBSA), or alkenylsuccinic acid.

In another particularly preferred embodiment, the hyperbranched polymer (c) used comprises a mixture comprising a hyperbranched polyester (c1) and a hydrophobicized hyperbranched polyester (c2).

If the component (b) used for production of the inventive isocyanate prepolymer comprises more than 50% by weight, based on the total weight of component (b), of a polyesterol, the content of hyperbranched polyester (c1) is preferably greater than 5% by weight, particularly preferably greater than 20% by weight, very particularly preferably greater than 50% by weight, and in particular 100% by weight, based on the total weight of the hyperbranched polymer (c).

If the component (b) used for production of the inventive isocyanate prepolymer comprises more than 50% by weight, based on the total weight of component (b), of a polyetherol, the content of hydrophobicized hyperbranched polyester (c2) is preferably greater than 10% by weight, particularly preferably greater than 30% by weight, very particularly preferably greater than 60% by weight, and in particular 100% by weight, based on the total weight of the hyperbranched polymer (c).

The amount present in the isocyanate prepolymer of the inventive hyperbranched polymers (c) is preferably from 0.001 to 50% by weight, particularly preferably from 0.01 to 30% by weight, and in particular from 0.1 to 10% by weight, based on the total weight of the polyisocyanates (a), of the compounds (b) reactive toward isocyanates, of the hyperbranched polymers (c), and, if appropriate, of the chain extenders and/or crosslinking agents (d).

Chain extenders and/or crosslinking agents (d) can also be used, if appropriate. The chain extenders and/or crosslinking agents (d) can be added prior to, together with, or after the addition of the polyols. Chain extenders and/or crosslinking agents (d) that can be used are substances whose molar mass is preferably smaller than 400 g/mol, particularly preferably from 60 to 350 g/mol, chain extenders here having 2 hydrogen atoms reactive toward isocyanates and crosslinking agents having 3 hydrogen atoms reactive toward isocyanate. These can be used individually or in the form of a mixture. If chain extenders are used, particular preference is given to 1,3- and 1,2-propanediol, dipropylene glycol, tripropylene glycol, and 1,3-butanediol.

If chain extenders, crosslinking agents, or a mixture of these are used, the amounts advantageously used of these are from 1 to 60% by weight, preferably from 1.5 to 50% by weight, and in particular from 2 to 40% by weight, based on the weight of polyisocyanates (a), of compounds (b) reactive toward isocyanate, of hyperbranched polymers (c), and of chain extenders and/or crosslinking agents (d).

The isocyanate prepolymers are obtainable by reacting polyisocyanates (a) described above, for example at temperatures of from 30 to 100° C., preferably at about 80° C., with compounds (b) reactive toward isocyanates and with hyperbranched polymer (c), and also, if appropriate, with chain extender and/or crosslinking agent (d) to give the prepolymer. It is preferable here that polyisocyanate (a), compound (b) reactive toward isocyanate, and hyperbranched polymer (c), and also, if appropriate, chain extenders and/or crosslinking agents (d) are mixed with one another in a ratio of isocyanate groups to groups reactive toward isocyanates of from 1.5:1 to 15:1, preferably from 1.8:1 to 8:1. It is particularly preferable that for preparation of the prepolymers, polyisocyanates and the compound having groups reactive toward isocyanates, and chain extenders and/or crosslinking agents are mixed with one another in a ratio such that the NCO content of the prepolymer prepared is in the range from 1.0 to 20% by weight, in particular from 2 to 15% by weight, based on the total weight of the isocyanate prepolymer prepared. Volatile isocyanates can then preferably be removed, preferably via thin-film distillation. The viscosity of the isocyanate prepolymers here is preferably from 1000 to 3000 mPa·s at 25° C. The viscosity of inventive isocyanate prepolymers based on toluene diisocyanate here is typically from 1000 to 1500 mPa·s, while the viscosity of inventive isocyanate prepolymers based on diphenylmethane diisocyanate here is typically from 2000 to 3000 mPa·s, in each case at 25° C.

The prepolymer having isocyanate groups can also be prepared stepwise. For this, a first step reacts the compound (b) reactive toward isocyanate and hyperbranched polymer (c), and also, if appropriate, chain extenders and/or crosslinking agents (d) with toluene 2,4-diisocyanate and/or toluene 2,6-diisocyanate until NCO content is from 2 to 5% by weight, based on the resultant prepolymer. A second step takes the resultant prepolymer and admixes it with isocyanates from the diphenylmethane diisocyanate series or their derivatives, e.g. diphenylmethane 2,4′-diisocyanate and diphenylmethane 4,4′-diisocyanate, and diphenylmethane diisocyanate homologs having a greater number of rings (polymer MDI) and/or room-temperature-liquid, modified diphenylmethane diisocyanates, in particular diphenylmethane diisocyanates modified via carbodiimide groups, via urethane groups, via allophanate groups, via isocyanurate groups, via urea groups, and/or via biuret groups, until the value of the NCO content of the prepolymer prepared corresponds to the values stated above. The content of monomeric isocyanate whose molar mass is smaller than 249 g/mol can be kept low by this method. The viscosity of these polyisocyanate prepolymers prepared stepwise is typically in the range from 2000 to 3000 mPa·s at 25° C.

The juncture of addition of the hyperbranched polymer (c) to the binder can be as desired. For example, the hyperbranched polymer (c) can be reacted and/or mixed directly with the polyisocyanate (a) during the preparation of isocyanate prepolymers, or else its addition can be delayed until after the reaction of the polyisocyanate (a) with the compound (b) reactive toward isocyanate, and, if appropriate, with the chain extender and/or crosslinking agent (d).

Further additives that can be added to the binder alongside the isocyanate prepolymer comprising hyperbranched polymer are those such as surfactants, plasticizers, inorganic fillers, e.g. sand, kaolin, chalk, barium sulfate, silicon dioxide, oxidation stabilizers, dyes, and pigments, stabilizers, e.g. with respect to hydrolysis, light, heat, or discoloration, inorganic and/or organic fillers, emulsifiers, flame retardants, antioxidants, adhesion promoters, and reinforcing agents.

The content of free, monomeric isocyanates whose molar mass is smaller than 249 g/mol in the binder is preferably smaller than 1% by weight, particularly preferably smaller than 0.5% by weight, and in particular smaller than 0.1% by weight, based on the total weight of the polyurethane binder.

For production of the layer materials, amounts of from 1 to 20 parts by weight, preferably from 3 to 10 parts by weight, based on 1 part by weight of the polyurethane binder, of the plastics granules are mixed in a manner known per se, if appropriate with addition of the auxiliaries and additives mentioned below, for example in a positive mixer.

The mixture can be hardened via addition of further compounds (b) reactive toward isocyanate and/or of chain extenders or crosslinking agents (d), and also of hyperbranched polymer (c), in what is known as the two-component process. As an alternative, the hardening can take place exclusively via exposure to water, in what is known as the single-component process. The hardening preferably takes place exclusively via exposure to water, particularly preferably via atmospheric moisture. Accelerated hardening can be achieved via spraying with water or else by means of steam-treatment. If the inventive layer material is produced by the single-component process, it is preferable to use no chain extender or crosslinking agent (d) for preparation of the prepolymer which has isocyanate groups.

The hardening process to give the binder can be accelerated via admixture of catalysts familiar in polyurethane chemistry, for example of tertiary amines and of organometallic compounds. Examples of catalysts used are amidines, such as 2,3-dimethyl-3,4,5,6-tetrahydropyrimidine, tertiary amines, such as triethylamine, tributylamine, dimethyl-benzylamine, N-methyl-, N-ethyl-, or N-cyclohexylmorpholine, N,N,N′,N′-tetramethyl-ethylenediamine, N,N,N′,N′-tetramethylbutanediamine, N,N,N′,N′-tetramethylhexane-diamine, pentamethyldiethylenetriamine, tetramethyldiaminoethyl ether, bis(dimethyl-aminopropyl)urea, dimethylpiperazine, 1,2-dimethylimidazole, 1-azabicyclo[3.3.0]-octane, and preferably 1,4-diazabicyclo[2.2.2]octane, and alkanolamine compounds, such as triethanolamine, triisopropanolamine, N-methyl- and N-ethyldiethanolamine and dimethylethanolamine. Other catalysts that can be used are organometallic compounds, preferably organotin compounds, such as stannous salts of organic carboxylic acids, e.g. stannous acetate, stannous octoate, stannous ethylhexonate, and stannous laurate, and the dialkyltin(IV) salts of organic carboxylic acids, e.g. dibutyltin diacetate, dibutyltin dilaurate, dibutyltin maleate, and dioctyltin diacetate, or else bismuth carboxylates, such as bismuth(III) neodecanoate, bismuth 2-ethylhexanoate, and bismuth octanoate, or a mixture thereof. The organometallic compounds can be used alone or in combination with basic amines. A preferred catalyst used is dimorphinodimethyl ether alone or in a mixture.

The juncture of addition of the catalyst here is not subject to any restriction. For example, the binder can by this stage comprise the catalyst, or the catalyst can be added during mixing with the plastics granules. If the catalyst is dimorphinodimethyl ether, the binder preferably comprises the catalyst by this stage.

It is preferable to add from 0.001 to 5% by weight, in particular from 0.05 to 2% by weight, of catalyst or catalyst combination, based on the weight of the compound (b) reactive toward isocyanate, of the hyperbranched polymer (c), and, if appropriate, of the chain extender and/or crosslinking agent (d).

In another, preferred embodiment, for the production of inventive layer materials, the plastics granules are, in a first step, mixed in a known manner, preferably in a mechanical mixer, with at least some of the hyperbranched polymer c) to be used and, if appropriate, with at least some of the compounds b) reactive toward isocyanates, and/or with chain extender, and/or crosslinking agent d) and also, if appropriate, with further additives. It is preferable that, in the first step, only the hyperbranched polymer c) and, if appropriate, further additives are mixed with the plastics granules.

Then, in a second step, component a) and any remaining amount of component b) reactive toward isocyanate, of the hyperbranched polymer c) and of the chain extender and/or crosslinking agent d), preferably in the form of an isocyanate prepolymer, are added to this mixture and likewise mixed.

The physical properties of the elastic sheet-like structures produced according to the invention, e.g. elasticity, hardness, density, and water-permeability, can be varied within wide limits via variation of size, shape, and nature of the plastics granules, binder content, average NCO functionality of the binder, content of isocyanate groups in the binder, degree of compaction, and hardening conditions.

The inventive layer material is usually shaped by using tooling and machinery known for production of floorcoverings and of road surfacings for broadcasting, distribution, and compaction of the mixture composed of polyurethane binder and of plastics granules onto the respective substrate to be coated, e.g. concrete, screed, or asphalt, at the desired layer thickness, which is generally from 2 to 30 mm in the specified application sectors. However, the shaping can also take place in, if appropriate heated, molds or presses, where the sheet-like structures are obtained after hardening in the form of sheets which then in turn are laid in a manner known per se for production of the specified coverings. To accelerate hardening, water is preferably added, particularly preferably in the form of steam, during shaping and hardening in heated molds or presses.

The inventive layer materials are preferably unformed, their density being from 0.2 to 2.0 g/cm³. The inventive layer materials moreover have increased durability and load-bearing capacity, this being in particular discernible in increased tensile strength. Inventive layer materials are therefore suitable in particular as covering for playing areas, athletics tracks, sports surfaces, and sports halls.

The invention is illustrated below by examples.

Inventive examples 1 to 3, comparative examples 1 and 2

The layer materials were produced according to table 1. This was done by, in a first step in a polypropylene container, mixing rubber granules with, if present, hyperbranched polyol at room temperature, using a Vollrath stirrer (stirrer diameter: 8.5 cm, stirrer speed: 750 revolutions per minute, stirring time: 2 minutes), until the rubber particles had been uniformly wetted. This was followed, in a second step, by addition of the isocyanate prepolymer and further mixing until the rubber particles had been uniformly covered with the binder. The mixture was then charged to a timber frame of dimensions 20×20×1.5 cm and compacted to about 1.5 cm thickness. The resultant layer materials were hardened for 7 days at room temperature and 50% relative humidity and then tested. Tensile strength and elongation at break to DIN 53 504 were determined here.

TABLE 1
Starting materials for production of the layer materials

| | Compar- | Inv. | Inv. | Compar- | Inv. |
|---|---|---|---|---|---|
| | ison 1 | ex. 1 | ex. 2 | ison 2 | ex. 3 |
| Binder [g] | 45.00 | 42.75 | 42.75 | 38.00 | 36.10 |
| HP1 [g] | | 2.25 | | | 1.90 |
| HP2 [g] | | | 2.25 | | |
| Rubber 1 [g] | 450 | 450 | 450 | | |
| Rubber 2 [g] | | | | 380 | 380 |
| Density of sheet | 711.3 | 719.9 | 712.2 | 621.0 | 621.2 |
| [kg/m³] | | | | | |

The starting materials used were as follows:

Binder: isocyanate prepolymer composed of 36 parts by weight of Lupranat® MI from Elastogran GmbH, a diphenylmethane diisocyanate with NCO content of 33.2%, 2 parts by weight of Lupranat® MM 103 from Elastogran GmbH, a modified diphenylmethane diisocyanate with NCO content of 29.5%, and 62 parts by weight of Lupranol® 1000, a polyetherol based on propylene oxide with OH number of 56 mg KOH/g. The NCO content of the isocyanate prepolymer was 10%.
Rubber 1: rubber granules from Krause (Dortmund), technical recycling-grade rubber based on SBR/EPDM
Rubber 2: rubber granules from RTW (Bindlach), granules derived from tire waste (15% car tires, 85% truck tires)
HP 1: hyperbranched polyester comprising hydroxy groups, carboxy groups, polyether groups, and branched alkyl radicals as functional elements, prepared to the following specification:
250 g of an adduct composed of polyisobutylene whose molar mass is about 550 g/mol and maleic anhydride (PIBSA 550), 304 g of a polyetherol based on trimethylolpropane, which had been grafted randomly with 12 ethylene oxide units, and 0.02 g of dibutyltin dilaurate were weighed into a 2 l glass flask equipped with stirrer, internal thermometer, and inclined condenser with vacuum connection, and heated to 160° C. at a pressure of 4 mbar, with stirring. Within a period of about one hour, the temperature was slowly increased to 180° C. The water produced during the reaction was removed by distillation, and some foaming of the experimental mixture occurred here, due to production of gas bubbles. The reduction in acid number was regularly monitored until the value achieved was below 10 mg KOH/g. The product was then cooled and analyzed.

### Analysis:

| | |
|---|---|
| Acid number: | 6 mg KOH/g |
| OH number: | 87 mg KOH/g |
| GPC: | Mₙ = 990 g/mol, M_{w} = 8900 g/mol (eluent: THF) |

HP 2: hyperbranched polyester comprising hydroxy groups, carboxy groups, polyether groups, and branched alkyl radicals as functional elements, prepared to the following specification:
593.3 g of an alkenylsuccinic acid (Pentasize 8), 459 g of a polyetherol based on trimethylolpropane randomly grafted with 3 ethylene oxide units, and 0.06 g of dibutyltin dilaurate were weighed into a 4 l glass flask equipped with stirrer, internal thermometer, and inclined condenser with vacuum connection, and heated slowly to 180° C., with stirring. A vacuum of 40 mbar was slowly applied here, whereupon the gas bubbles produced caused some foaming of the mixture. The reaction mixture was stirred at 180° C. for 0.5 h, and the water produced in the reaction was removed here by distillation.

The fall-off in acid number was checked regularly until the value reached was about 75.1 mg KOH/g. The product was then cooled and analyzed.

### Analysis:

| | |
|---|---|
| Acid number: | 75.1 mg KOH/g |
| OH number: | 80.8 mg KOH/g |
| GPC: | Mₙ = 1700 g/mol, M_{w} = 4700 g/mol (eluent: DMAC) |

### Analysis of Hyperbranched Polymers

The polymers were analyzed by gel permeation chromatography using a refractometer as detector. Tetrahydrofuran (THF) or dimethylacetamide (DMAc) was used as mobile phase, and polymethyl methacrylate (PMMA) was used as standard for molecular weight determination.

Glass transition temperatures Tg were determined by means of differential scanning calorimetry (DSC), evaluating the second heating curve.

Acid number determination and OH number determination followed DIN 53240, part 2.

Table 2 states the mechanical properties of the resultant layer materials.

TABLE 2

| | Compar- | Inv. | Inv. | Compar- | Inv. |
|---|---|---|---|---|---|
| | ison 1 | ex. 1 | ex. 2 | ison 2 | ex. 3 |
| Tensile strength | 160 | 204 | 198 | 113 | 142 |
| [kPa] | | | | | |
| Elongation [%] | 18 | 21 | 23 | 19 | 27 |

Table 2 shows that tensile strength and elongation are increased via addition of hyperbranched polymer.

1. A polyurethane binder, comprising a prepolymer wherein said prepolymer has isocyanate groups and is obtained by reacting or mixing a polyisocyanate (a) with a compound (b) reactive toward isocyanates, with hyperbranched polymer (c), and also, optionally, with at least one of a chain extender and a crosslinking agent (d) wherein an excess of the polyisocyanate (a) is used, wherein the hyperbranched polymer has a weight-average molar mass greater than 500 g/mol and a degree of branching greater than or equal to 0.05, and the viscosity of the binder at 25° C. is from 500 to 4000 mpPa·s.

2. The polyurethane binder according to claim 1, wherein the hyperbranched polymer (c) and the prepolymer which has isocyanate groups are present in the form of a physical mixture, or the hyperbranched polymer (c) is bonded via covalent bonding to the polymer matrix of the prepolymer which has isocyanate groups.

3. The polyurethane binder according to claim 1, wherein the NCO content of the isocyanate prepolymer is in the range from 1.0 to 20, based on the total weight of the isocyanate prepolymer.

4. The polyurethane binder according to claim 1, wherein from 0.001 to 50% by weight, based on the total weight of the binder, of the hyperbranched polymer (c) is present in the polyurethane binder.

5. The polyurethane binder according to claim 1, wherein the weight-average molar mass of the hyperbranched polymer (c) is greater than 500 g/mol and the degree of branching of the hyperbranched polymer (c) is greater than or equal to 0.05.

6. The polyurethane binder according to claim 1, wherein the hyperbranched polymer (c) is a hyperbranched polymer comprising ethers, amines, esters, carbonates, amides, urethanes, ureas, or a mixed form thereof.

7. The polyurethane binder according to claim 1, wherein the hyperbranched polymer (c) comprises at least one of molecular domains generating hydrophobic interactions and groups reactive toward free-radical polymerization.

8. The polyurethane binder according to claim 1, wherein the hyperbranched polymer is a hyperbranched polyester d1) obtained by esterifying α,β-unsaturated carboxylic acids or their derivatives with polyhydric alcohols.

9. The polyurethane binder according to claim 1, wherein the hyperbranched polymer (c) is a hyperbranched polymer comprising hydrophobic units having more than 6 carbon atoms.

10. The polyurethane binder according to claim 9, comprising, as hydrophobic unit, a fatty acid radical or a fatty alcohol radical.

11. The polyurethane binder according to claim 1, wherein the hyperbranched polymer (c) is a hyperbranched polyester (c2) obtained by esterifying α,β-unsaturated carboxylic acids or their derivatives with polyhydric alcohols, wherein the α,β-unsaturated carboxylic acids or their derivatives are hydrophobicized prior to or after esterification with a hydrophobicizing agent comprising at least one carbon-carbon double bond.

12. The polyurethane binder according to claim 11, wherein the hydrophobicizing agent is linear or branched polyisobutylene.

13. The polyurethane binder according to claim 1, wherein the compound (b) having at least two reactive hydrogen atoms comprises at least 50% by weight, based on the total weight of the compound (b), of a polyesterol, and the hyperbranched polymer (c) comprises at least 5% by weight, based on the total weight of the hyperbranched polymer (c), of a hyperbranched polyester (c1).

14. The polyurethane binder according to claim 1, wherein at least one said compound (b) having at least two reactive hydrogen atoms comprises at least 50% by weight, based on the total weight of the compound (b), of a polyetherol, and the hyperbranched polymer (c) comprises at least 10% by weight, based on the total weight of the hyperbranched polymer (c), of a hyperbranched polyester (c2).

15. The polyurethane binder according to claim 1, wherein the content of isocyanates whose molar mass is smaller than 249 g/mol in the binder is smaller than 1% by weight, based on the total weight of the polyurethane binder.

16. The polyurethane binder according to claim 1, wherein the NCO content in the isocyanate prepolymer is from 2 to 18% by weight, based on the weight of the prepolymer comprising isocyanate groups.

17. A process, comprising mixing a binder according to claim 1 with plastics granules and, optionally, with catalyst and with other additives, and hardening to provide an elastic layer material.

18. A process, comprising mixing plastics granules with a polyisocyanate (a), with a compound (b) reactive toward isocyanates, with hyperbranched polymer (c), optionally with at least one of a chain extender and a crosslinking agent (d), and also, optionally, with further additives, wherein the process comprises (i) mixing plastics granules with at least one hyperbranched polymer c), and (ii) adding the isocyanate prepolymer a) to this mixture and mixing.

19. The process according to claim 18, wherein (i) said mixing plastics granules with at least one hyperbranched polymer further comprises mixing the hyperbranched polymer c), at least one compound b) reactive toward isocyanates, optionally at least one of a chain extender and a crosslinking agent d), and also, optionally, further additives with the plastics granules.

20. The process according to claim 18, wherein, said (ii) adding the isocyanate prepolymer a) to the mixture comprises adding isocyanate prepolymer a), and at least one compound b) reactive toward isocyanates, optionally at least one of a chain extender and a crosslinking agent d), in the form of an isocyanate prepolymer.

21. The process according to claim 17, wherein the hardening takes place with exposure to water.

22. The process according to claim 17, wherein the plastics granules used comprise rubber granules comprising butadiene rubber (BR), styrene-butadiene rubber (SBR), isoprene rubber (IR), styrene-isoprene-butadiene rubber (SIBR), acrylonitrile-butadiene rubber (NBR), chloroprene rubber (CR), isobutene-isoprene rubber (IIR), EPDM and natural rubber (NR), or a mixture thereof, wherein the rubber granules are vulcanized by at least one of a vulcanization accelerator and a crosslinking agent comprising sulfur or peroxide.

23. An elastic layer material obtained by a process according to claim 17.

24. A covering material for a playing area, an athletics track, a sports hall, a children's play area or walkway, comprising an elastic layer material according to claim 23.
